(19) United States
(12) Patent Application Publication
(10) Pub. No.: US 2018/0347081 A1
(43) Pub. Date: Dec. 6, 2018

(54) ELECTRICAL RESISTANCE-VARIABLE CONDUCTIVE ELASTICIZED KNITTED FABRIC AND CONDUCTIVE PART

(71) Applicant: GUNZE LIMITED, Ayabe-shi, Kyoto (JP)

(72) Inventors: Takaomi KURAHASHI, Ayabe-shi (JP); Yoshimi TANAKA, Ayabe-shi (JP)

(73) Assignee: GUNZE LIMITED, Ayabe-shi, Kyoto (JP)

(21) Appl. No.: 15/562,298

(22) PCT Filed: Jun. 20, 2016
(86) PCT No.: PCT/JP2016/068203

§ 371 Date: Sep. 27, 2017

(30) Foreign Application Priority Data
Jul. 14, 2015 (JP) 2015-140652

(51) Int. Cl. D04B 1/18; A41D 31/00; D04B 1/10; D04B 1/24; G01B 7/16

(52) U.S. Cl. CPC D04B 1/18; A41D 31/00; D04B 1/102; D04B 1/24; D10B 2401/16; D10B 2101/20; D10B 2331/10; D10B 2401/061; D10B 2501/04; G01B 7/18

(57) ABSTRACT

Provided is a highly elastic and pliant knitted fabric which affords restorability against repetitive stretching, has characteristic of varying in electrical resistance with state changes between stretched state and unstretched state, and may provide air permeability, moisture permeability, and water absorbability for suitable use as wearable material. A direction in which continuous loops are successively formed in knit structure is defined as course direction or course, loops are formed of conductive yarn, elastic yarn is positioned so as to exhibit tightening force in course direction, and the knitted fabric is designed so that, when in unstretched state, conductive yarn loops arranged adjacent each other in course direction are kept in contact with each other under tightening force of elastic yarn, whereas, in a state of being stretched in course direction, conductive yarn loops move away from each other against tightening force of elastic yarn.

### TECHNICAL FIELD

The present invention relates to a conductive elasticized knitted fabric having the characteristic of varying in electrical resistance with changes in its state between a stretched state and an unstretched state, and a conductive part which employs the elasticized knitted fabric.

### BACKGROUND ART

There is a heretofore proposed cloth comprising a base fabric serving as a cloth main body and a stack of a distortion sensor and a wiring section placed on one surface of the cloth main body (Patent Literature 1). The distortion sensor provided in this cloth is constructed by successively placing short-cut CNT (Carbon Nano Tube) fibers in parallel with one another to define a linear arrangement on an elastic substrate such as a rubber substrate, and disposing electrodes one at each end of the linear arrangement. The electrode at each end and the described wiring section are connected to each other for electrical conduction.

As this cloth is expanded and contracted in the direction in which the electrodes at opposite ends move close to and away from each other, the spaced interval between the CNT fibers constituting the distortion sensor increases and decreases correspondingly, thus causing variations in electrical resistance between the electrodes.

As is apparent from this construction, the reason for forming the substrate of the distortion sensor from an elastic rubber is to permit a change, namely an increase or a decrease, in the spacing at which the CNT fibers are arranged in response to the expansion and contraction of the cloth, as well as to achieve a quick elastic restoration from a stretched state to a normal state having an original length without fail.

### PRIOR ART REFERENCE

### CITATION LIST

Patent Literature 1: Japanese Unexamined Patent Publication JP-A 2014-25180

### SUMMARY OF INVENTION

### Technical Problem

It is well known that CNT fibers exhibit outstanding mechanical strength against a tension exerted thereon in a fiber direction. However, in the cloth disclosed in Patent Literature 1, the expansion and contraction of the distortion sensor involve the changes of the CNT fiber-to-CNT fiber spacing. That is, the CNT fiber in itself is not stretched in the fiber direction, wherefore the mechanical strength of the CNT fiber is not conducive to the mechanical strength of the cloth.

After all, the mechanical strength of the cloth is governed by the rubber strength of the substrate constituting the distortion sensor. This necessitates the implementation of mechanical-strength enhancement measures such as an increase in hardness of a rubber material used for the substrate or an increase in rubber thickness. However, such a measure is contradictory to attempts to improve the yieldability of the distortion sensor (sufficient stretching extent, elastic restorability against stretching actions, quick restoration, resistance to repeated stretching actions, etc.), which ends in difficulties in satisfying all of these requirements.

Meanwhile, the distortion sensor, comprising a rubber-made substrate, is not capable of exhibiting air permeability, moisture permeability, and water absorbability. Thus, the attachment of this distortion sensor to garments and so forth will inevitably cause wearer's discomfort resulting from heat and humidity. This makes it difficult to apply the distortion sensor to a wearable material as a matter of practicality.

The present invention has been devised to cope with the circumstances as discussed supra, and accordingly an object of the invention is to provide electrical resistance-variable conductive elasticized knitted fabric and conductive part that are each of a highly elastic and pliant knitted fabric which affords restorability against repeated stretching actions, is possessed of the characteristic of varying in electrical resistance with changes in state between a stretched state and an unstretched state, and can be designed to provide air permeability, moisture permeability, and water absorbability for suitable use as a wearable material.

### Solution to Problem

In order to accomplish the above object, the present invention takes the following means.

That is, the electrical resistance-variable conductive elasticized knitted fabric pursuant to the present invention is a knitted fabric for which a direction in which continuous loops are formed one after another in a knit structure is defined as a course direction or a course, in which the loops are formed of conductive yarn, and elastic yarn is positioned so as to exhibit a tightening force in the course direction, the knitted fabric being designed so that, when in an unstretched state, the conductive yarn loops arranged adjacent each other in the course direction are kept in contact with each other under the tightening force of the elastic yarn, whereas, in a state of being stretched in the course direction, the conductive yarn loops are movable away from each other against the tightening force of the elastic yarn.

It is preferable that the conductive yarn is knitted by weft knitting.

The elastic yarn can be knitted in the course direction from a knitting point which is the same as or different from a knitting point from which is fed the conductive yarn.

The elastic yarn can alternatively be interwoven in the course direction by inlay knitting.

In this case, in the knitted fabric, the elastic yarn is advisably held securely at opposite ends of the knitted fabric in the course direction by fixing means for yarn retention.

On the other hand, the conductive part pursuant to the present invention comprises a conductive portion and a non-conductive portion placed next to the conductive portion, the conductive portion being a knitted fabric for which a direction in which continuous loops are formed one after another in a knit structure is defined as a course direction or a course, in which the loops are formed of conductive yarn, and elastic yarn is positioned so as to exhibit a tightening force in the course direction, the conductive part being designed so that, when the knitted fabric is in an unstretched state, the conductive yarn loops arranged adjacent each other in the course direction are kept in contact with each other under the tightening force of the elastic yarn, whereas, when the knitted fabric is in a state of being stretched in the course direction, the conductive yarn loops are movable away from each other against the tightening force of the elastic yarn.

The present invention may also take the following means.

That is, the electrical resistance-variable conductive elasticized knitted fabric pursuant to the present invention is a knitted fabric, for which a direction in which continuous loops are formed one after another in a knit structure is defined as a course direction or a course and a direction perpendicular to the course direction on the surface of the knitted fabric is defined as a wale direction or a wale, comprising a non-conductive knit region made solely of non-conductive yarn loops and a wale conductive strip placed next to the non-conductive knit region, the wale conductive strip being formed of a chain of conductive yarn loops arranged in the wale direction so as to be stretchable in the wale direction.

It is preferable that the wale conductive strip is interposed in sandwich relation between the non-conductive knit regions.

A course conductive strip may be formed with use of conductive yarn for the loops constituting the course direction so as to be stretchable in the course direction, and, the course conductive strip and the wale conductive strip may be intersected by each other.

In this case, one of the wale conductive strip and the course conductive strip may be provided in the form of a plurality of paralleled conductive strips, and, the other is disposed so as to run across the paralleled conductive strips to define a short-circuit path.

### Advantageous Effects of Invention

The conductive elasticized knitted fabric and the conductive part pursuant to the present invention are each of a highly elastic and pliant knitted fabric which affords restorability against repeated stretching actions, is possessed of the characteristic of varying in electrical resistance with changes in state between a stretched state and an unstretched state, and can be designed to provide air permeability, moisture permeability, and water absorbability for suitable use as a wearable material.

### BRIEF DESCRIPTION OF DRAWINGS

FIG. 1 is a view schematically showing the knit structure of a conductive elasticized knitted fabric pursuant to the present invention in an unstretched state.

FIG. 2 is a view schematically showing the knit structure of the conductive elasticized knitted fabric of the present invention in a stretched state.

FIG. 3 is a plan view schematically showing an example of application of the conductive elasticized knitted fabric of the present invention.

FIG. 4 is a view schematically showing a knit structure in another pattern (stretched state) with elastic yarn interwoven by inlay motion.

FIG. 5 is a view schematically showing a knit structure in still another pattern (stretched state) with elastic yarn interwoven by inlay motion.

FIG. 6A is a view schematically showing a knit structure in an unstretched state with elastic yarn interwoven by plating stitch.

FIG. 6B is a view schematically showing a knit structure in a stretched state with elastic yarn interwoven by plating stitch.

FIG. 7 is a view schematically showing the knit structure of an embodiment of the conductive elasticized knitted fabric of the present invention (hereafter referred to as “the second embodiment”) in an unstretched state (normal state).

FIG. 8 is a plan view schematically showing the conductive elasticized knitted fabric implemented as the second embodiment.

FIG. 9 is a perspective explanatory view schematically showing a procedure in the making of the conductive elasticized knitted fabric implemented as the second embodiment.

FIG. 10 is a graph indicating a stretching (length)-electrical resistance relationship in a wale conductive strip.

FIG. 11A is a schematic representation of a condition where adjacent conductive yarn loops make contact with each other with consequent variation in electrical resistance in the wale conductive strip.

FIG. 11B is a schematic representation of a condition where adjacent conductive yarn loops are brought into contact in partly overlying relation with each other with consequent variation in electrical resistance in the wale conductive strip.

FIG. 12 is a perspective explanatory view schematically showing a procedure in the making of another embodiment of the conductive elasticized knitted fabric of the present invention (hereafter referred to as “the third embodiment”).

### DESCRIPTION OF EMBODIMENTS

Hereinafter, embodiments of the present invention will be described with reference to drawings.

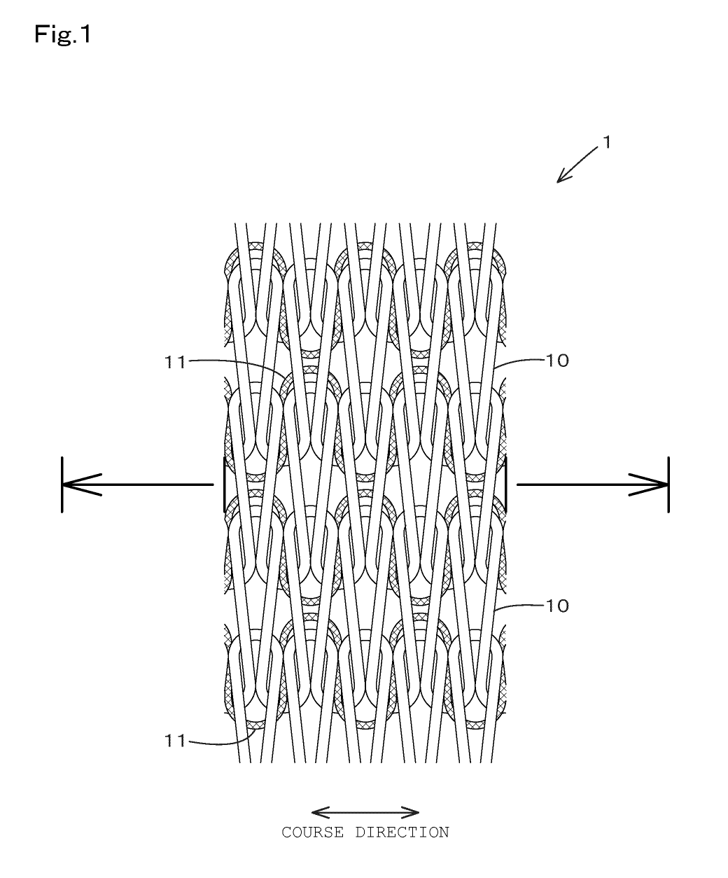

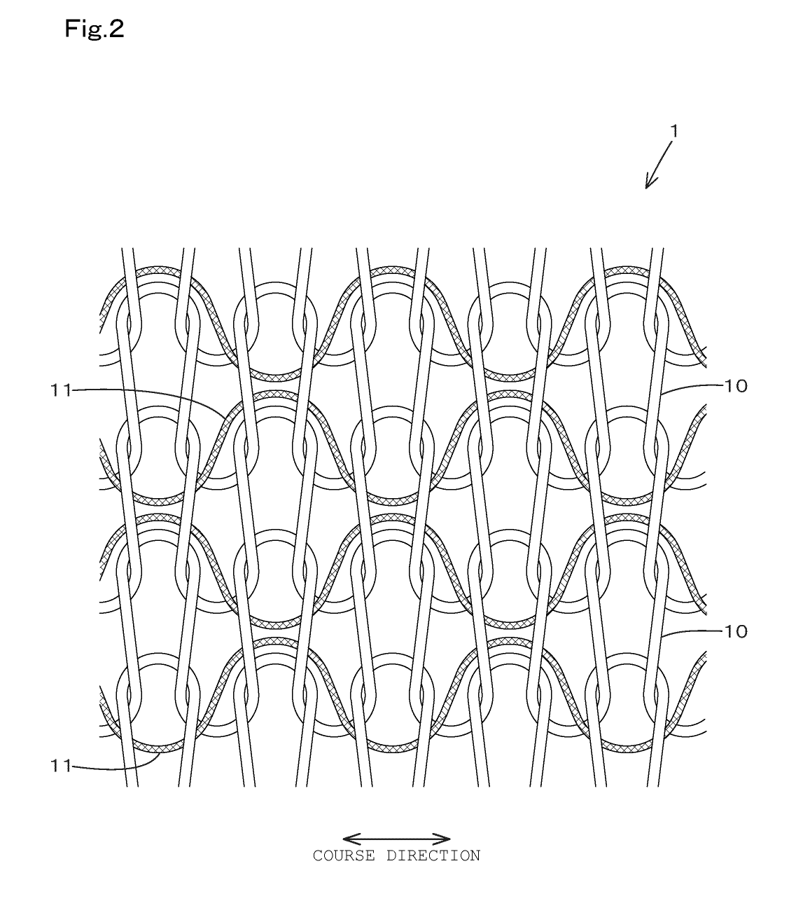

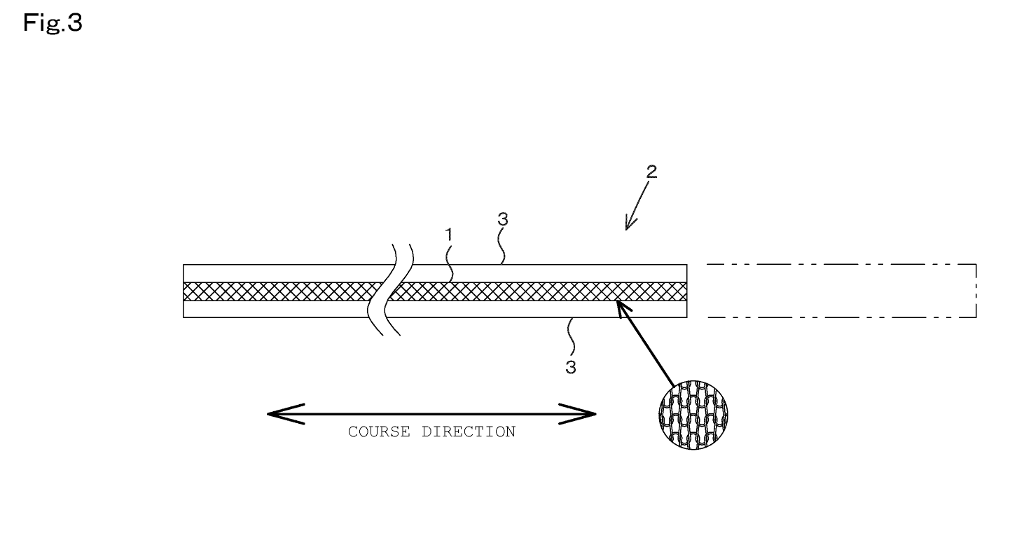

FIGS. 1 and 2 are views showing an electrically conductive elasticized knitted fabric 1 pursuant to the present invention. The conductive elasticized knitted fabric 1 can be used as one constituent element in the production of a conductive part 2 as shown in FIG. 3, for example.

The conductive part 2 is shaped in a flat tape comprising non-conductive portions 3 located one on each side edge of the tape in a width direction and a narrow strip-like conductive portion interposed between the opposite non-conductive portions 3 so as to be located centrally of the tape in the width direction. The conductive portion is constituted by the conductive elasticized knitted fabric 1 of the present invention (hereafter referred to as “the first knitted fabric 1 of the invention”).

The first knitted fabric 1 of the invention and the non-conductive portions 3 are integral to form the conductive part 2 which is highly stretchable in a longitudinal direction, and has flexibility of high enough level to warp or bend toward a front-back direction, bend rightward and leftward in a planar direction, and twist freely, for example. The first knitted fabric 1 of the invention, which is designed to exhibit conductivity at its area between any given two longitudinally spaced apart points, is characterized in that, as the conductive part 2 is stretched and contracted in the longitudinal direction, the electrical resistance between the described two points therein varies according to the degree of stretching of the conductive part.

In the conductive part 2, a plurality of the first knitted fabrics 1 of the invention may be arranged widthwise while being separated by the non-conductive portion 3. Moreover, the first knitted fabric 1 of the invention may be shaped in a broad strip or line instead of a narrow strip shape. That is, there is no particular limitation to the arrangement and the number of the first knitted fabrics 1 of the invention to be formed. Moreover, the configuration of the conductive part 2 in itself is not limited to a tape-like shape, but maybe defined by a quadrangular shape such as a square or rectangle.

Moreover, as will hereafter be described, the first knitted fabric 1 of the invention has its own restorability against stretching actions (contractility). Hence, the non-conductive portion 3 may be omitted from the structure. That is, the application of the first knitted fabric 1 of the invention is not limited to the conductive part 2. However, it is advisable to provide the non-conductive portion 3 in view of its capability of preventing electrical shortings or leakage of current caused in the first knitted fabric 1 of the invention due to a contact between the side edge of the conductive part 2 and other object. Besides, the non-conductive portion 3 is conducive to enhancement in stretchability for the first knitted fabric 1 of the invention and facilitation of bending and twisting movement.

In the conductive part 2, both of the first knitted fabric 1 of the invention and the non-conductive portion 3 have a knit structure in a condition of being exposed at the front and back sides of the conductive part 2 (the wall thickness of the conductive part 2 is defined by the wall thickness of the first knitted fabric 1 of the invention and the wall thickness of the non-conductive portion 3 as well). Of these constituent pieces, the non-conductive portion 3 is knitted out solely of non-conductive yarn made of synthetic fiber (nylon or polyester, for example), natural fiber, a synthetic fiber-elastic yarn composite material, etc.

On the other hand, the first knitted fabric 1 of the invention is knitted by interweaving the conductive yarn 10 and elastic yarn 11. As employed herein, the term “conductive yarn” refers to a bare yarn material with a metallic component left exposed on yarn surface. Moreover, the term “elastic yarn” refers to a material which remains contracted at no load of tension (unstretched state, viz., normal state), stretches freely under a load of tension in accordance with the level of the tension, and restores from the stretched state to the original contracted state when brought into a no-load condition on release of the tension.

It is preferable to use, as the conductive yarn 10, metal-deposited yarn obtained by depositing a metallic component on a core such as resin fiber, natural fiber, or a metallic wire by means of wet coating, dry coating, plating, vacuum film deposition, or otherwise (plated yarn). Although monofilament yarn can be used for the core, multifilament yarn or spun yarn is better than monofilament yarn, or, bulky yarn, such as woolly-finished yarn, covered yarn such as SCY or DCY, or fluffy-finished yarn, is more preferable for use.

As the metallic component deposited on the core, use can be made of, for example, pure metal such as aluminum, nickel, copper, titanium, magnesium, tin, zinc, iron, silver, gold, platinum, vanadium, molybdenum, tungsten, and cobalt, an alloy of such metals, stainless steel, and brass.

Meanwhile, to form the elastic yarn 11, an elastomeric material such as polyurethane or a rubber material may be used alone, or, for example, use can be made of covered yarn composed of a “core” made of an elastomeric material such as polyurethane or a rubber material and a “cover” made of nylon or polyester. The use of such a covered yarn makes it possible to impart various features, including an affinity for water, water repellency, resistance to corrosion, and coloration, to the first knitted fabric 1 of the invention. Moreover, its use is effective at providing a smooth texture and exercising stretching control. Note that yarn containing a conductive material can also be used for the elastic yarn 11.

It is advisable to select materials used for the elastic yarn 11 with consideration given to the fact that stretching of the conductive yarn 10 has to be limited so as not to exceed the maximum stretching limit. When adopting covered yarn as the elastic yarn 11, a material which lends itself to stretching control on the conductive yarn 10 can be selected as a material used for the “cover”. Moreover, the selection of materials used for the elastic yarn 11 in itself or the “cover” may be made with the aim of attaining adaptability to stretching and contracting behaviors required of the first knitted fabric 1 of the invention. Note that the non-conductive portion 3 may serve the purpose of regulating the stretching of (the load on) the conductive yarn 10.

As specific means for interweaving the conductive yarn 10 and the elastic yarn 11 with each other to knit the first knitted fabric 1 of the invention, in this embodiment, a knit structure as shown in FIG. 1 or FIG. 2 is obtained by weaving the conductive yarn 10 by plain stitch (or called single stitch) and then interweaving the elastic yarn 11 in the course direction with the plain stitch fabric of the conductive yarn 10 by inlay motion.

In the inlay knit pattern as exemplified in FIGS. 1 and 2, the elastic yarn 11 is interwoven with the conductive yarn 10 on a single elastic-yarn course-per-conductive yarn course basis, and, the elastic yarn 11 is interwoven so as to run along the conductive yarn 10 while being entangled in a conductive yarn 10 loop.

However, the use of plain stitch, inlay motion, or its combination does not suggest any limitation to knitting techniques. Furthermore, as long as the conductive yarn 10 and the elastic yarn 11 are both included, additional yarn of different type (which may also be elastic yarn) maybe interwoven therewith.

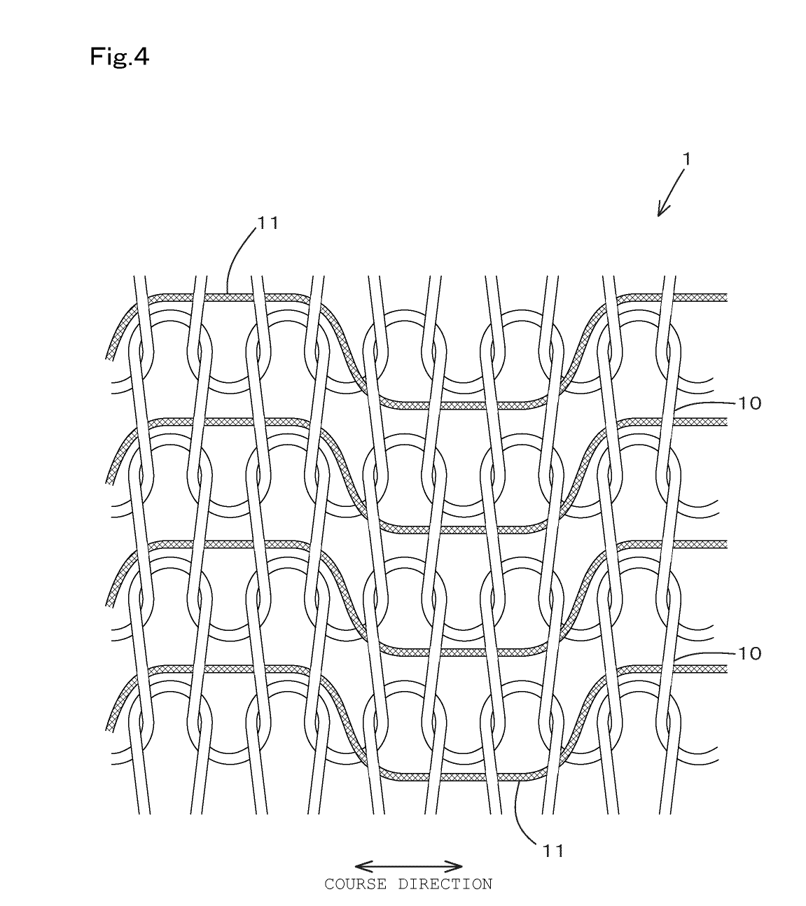

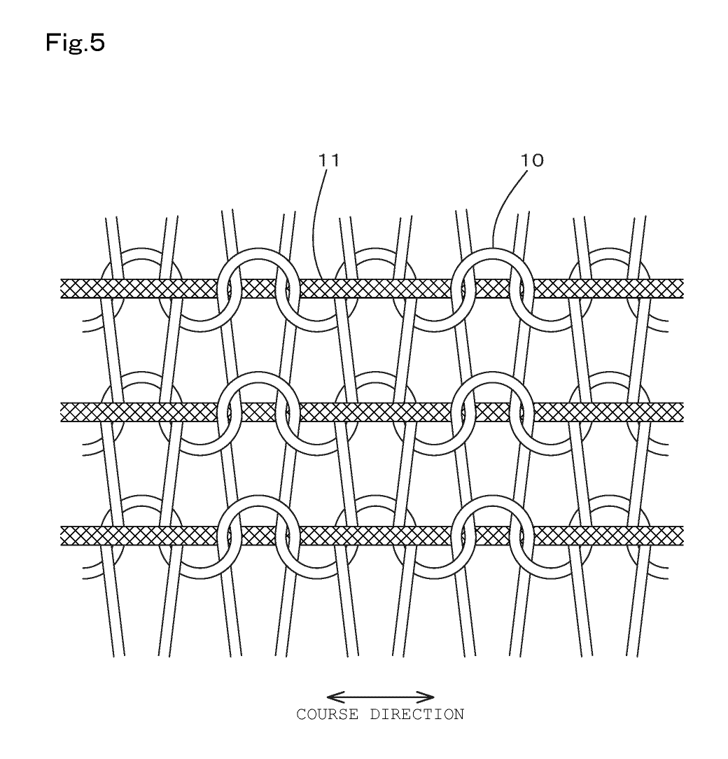

For example, as shown in FIG. 4, the elastic yarn 11 can be interwoven so as to get less entangled with the conductive yarn 10. Strictly speaking, the drawings such as FIGS. 1, 2, and 4 are merely schematic representations, and the orderly defined pattern as shown therein is therefore impractical. In reality, the elastic yarn 11 assumes a zigzag pattern which looks somewhat like a straight line compared to the pattern as shown in the drawings. In some instances, as shown in FIG. 5, the elastic yarn 11 can be interwoven in a linear pattern intentionally.

The term “course direction” refers to a direction in which continuous loops are formed one after another to define a knit structure, and this direction coincides with “course”. A direction perpendicular to the course direction on the surface of the knitted fabric will be referred to as “wale” or “wale direction”. Moreover, the term “course number” refers to the number of courses arranged side by side in the wale direction.

For example, the thereby configured conductive part 2 (refer to FIG. 3) can be produced in accordance with the method described in Japanese Unexamined Patent Publication JP-A 11-279937 (1999) (the method for producing a tape-shaped fabric from tubular textile stuff). That is, in the process of knitting a tubular fabric using a circular knittingmachine, three sections in total, namely the non-conductive portion 3, the first knitted fabric 1 of the invention, and the non-conductive portion 3 arranged in the order named, are knitted out of yarn fed from a plurality of yarn feeders simultaneously, and, connecting threads, which are dissolved by heat, water, or solvent, are inserted among the fabric pieces. The tubular fabric so obtained is subjected to connecting-thread dissolving treatment, whereby the conductive parts 2 can be taken out separately in a spiral fashion.

The conductive part 2 exhibits the following characteristic effects under a load of tension exerted in the course direction and on release of the tension. The same holds true for the conductive part 2 composed solely of the first knitted fabric 1 of the invention without using the non-conductive portion 3.

That is, in the range of the first knitted fabric 1 of the invention constituting the conductive part 2, the elastic yarn 11 is interwoven in the course direction with the plain stitch fabric of the conductive yarn 10. Thus, the elastic yarn 11 acts to tighten the plain stitch fabric of the conductive yarn 10 in the course direction.

Thus, in the conductive part 2 in an unstretched (normal) state at no load of tension, as shown in FIG. 1, with the fabric tightening effect of the elastic yarn 11, the conductive yarn 10 loops arranged adjacent each other in the course direction are kept in contact with each other. At the same time, the individual conductive yarn 10 loops are forced to contract (shrink) in the course direction, and remains deformed in this state.

The conductive yarn 10 is an electrically conductive bare yarn material, wherefore, as the number of loop-to-loop contact points is increased, or as the area of contact is widened due to forcible shrinkage in the course direction, the number of contact points for conduction, viz., the area of conduction becomes increasingly larger, with consequent attainment of a shorter current-carrying path. This makes it possible to minimize the electrical resistance between two locations spaced apart in the course direction in the first knitted fabric 1 of the invention.

However, upon the conductive part 2 being stretched in the course direction by pulling force as shown in FIG. 2, in the first knitted fabric 1 of the invention, the conductive yarn 10 loops in contact move away from each other against the tightening force exerted by the elastic yarn 11. At this time, the conductive yarn 10 loops, rather than getting away from one another all together in one swift movement, undergo transitions in state, and more specifically, for example, while some still remain in contact even with gradual decrease in contact pressure in proportion to the degree of stretching of the first knitted fabric 1 of the invention (the contact area becomes increasingly narrower than in the unstretched state), others are brought out of contact and move farther and farther away from each other, or remain in contact as in the unstretched state.

Thus, after the start of stretching of the first knitted fabric 1 of the invention in the unstretched state, as the degree of stretching is increased, there arise tendencies that the area of conduction is decreased, the current-carrying path is lengthened, and the electrical resistance is gradually increased.

As a matter of course, upon release of the tension on the conductive part 2, the conductive part 2 contracts in the course direction under the tightening force exerted in the course direction by the elastic yarn 11 for restoration to the unstretched state. Thus, in the first knitted fabric 1 of the invention, the electrical resistance tends to decrease as the area of conduction is increased.

The contraction of the conductive part 2 in the course direction may be either induced solely by the contractility of the first knitted fabric 1 of the invention in itself, or induced by causing the first knitted fabric 1 of the invention and the non-conductive portion 3 to contract in conjunction with each other.

Thus, the conductive part 2 can suitably be used for a distortion sensor and so forth with the exploitation of the described characteristics. It is noteworthy that the first knitted fabric 1 of the invention and the non-conductive portion 3 are each formed in a knit structure, and thus afford air permeability, moisture permeability, and water absorbability. Hence, the attachment of the conductive part 2 to garments, for example, will not cause wearer's discomfort resulting from heat and humidity. It can thus be said that the conductive part 2 (and the first knitted fabric 1 of the invention as well) is suitable for use in wearable material application.

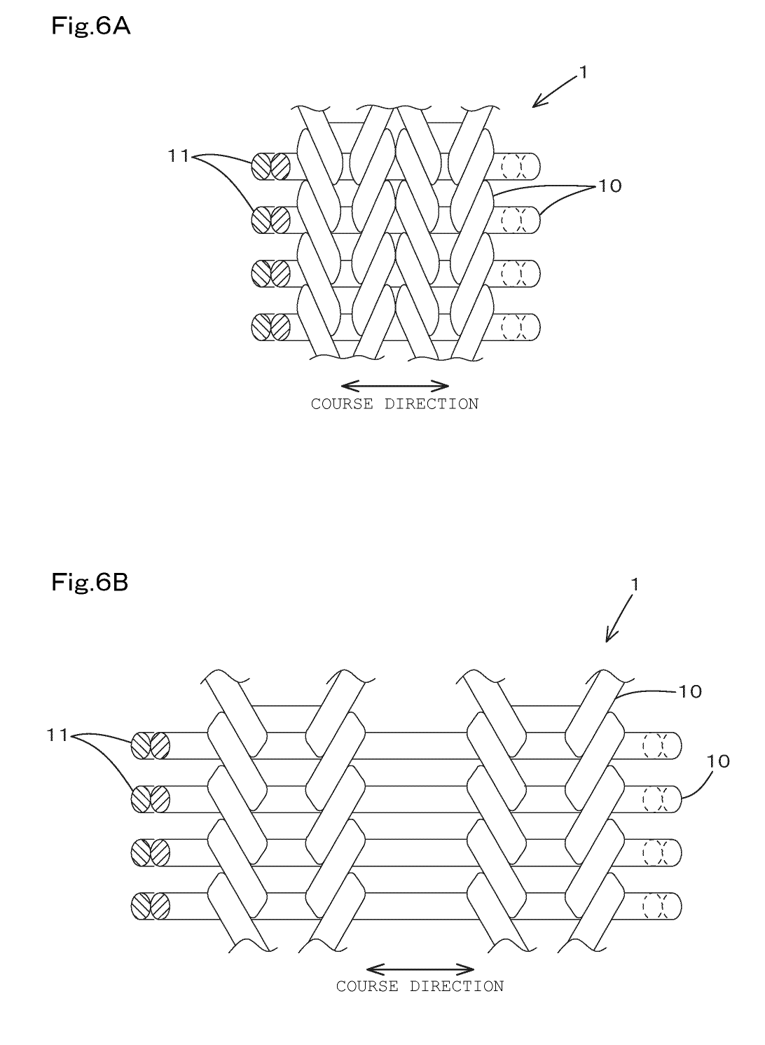

FIG. 6A is a view of a knit structure obtained by interweaving the conductive yarn 10 with the elastic yarn 11 by plating stitch, illustrating an unstretched state (normal state at no load of tension). Moreover, FIG. 6B is a view of a knit structure obtained by interweaving the conductive yarn 10 with the elastic yarn 11 by plating stitch, illustrating a state of stretching in the course direction. In the plating's case, the conductive yarn 10 and the elastic yarn 11 distinctively and separately come to the surface at the front and back sides of the knitted fabric. In the drawings, there is shown the knit structure viewed as from the side where the conductive yarn 10 comes to the surface, with the elastic yarn 11 hidden behind the conductive yarn 10, only the section of it being shown.

In addition to plating stitch, a technique of paralleling some yarns together or feeding some yarns together may be adopted. Moreover, although the conductive yarn 10 is illustrated as having a single (plain) knit structure, it is needless to say that it may be designed to have another knit structure such for example as fraise (rib) knit structure.

In the case of adopting plating stitch, it has been found particularly desirable to perform heat setting treatment after causing the knitted fabric in finished form to contract in the course direction so that the adjacent loops can be kept in contact with each other (or stay stationary at no load of tension) in the interest of ensuring that the first knitted fabric 1 of the invention will exhibit low-resistance characteristics when in the unstretched state.

As additional remarks, in the case of performing heat setting treatment on an ordinary knitted fabric, it is customary to hold the knitted fabric in a fixed length in the course direction or to stretch it actively. With consideration given to this fact, the technique of keeping the knitted fabric in a contracted state in the course direction during heat setting treatment may be considered as a unique production method. However, heat setting treatment does not necessarily have to be performed in the course production of the first knitted fabric 1 of the invention using plating stitch.

The level of electrical resistance in the first knitted fabric 1 of the invention can be controlled appropriately by making changes to the distance between the two locations set for the acquisition of electrical conductivity or the widthwise dimensions of the knitted fabric (the number of courses in the width direction). Moreover, a reduction in electrical resistance value in a single course can be achieved by increasing the number of the conductive yarn 10 constituting a single course by means of S twist or Z twist, paralleling some yarns together, plating stitch, or otherwise, by selecting a low-resistance material for the conductive yarn 10, by increasing the thickness, or by increasing the amount of plating to be applied. In addition, the smaller the flexural rigidity the better, because excellent expansion and contraction properties can be obtained. It is thus advisable to tie fibers of small fiber diameter in a bundle.

Where the level of stretchability of the first knitted fabric 1 of the invention is concerned, for example, when it is desired that the knitted fabric in the stretched state jump back (restore quickly) to the normal state, it is advisable to select relatively thick yarn of high stretchability as the elastic yarn 11, and, on the other hand, when it is desired that the knitted fabric in the stretched state restore to the original state by slow degrees, it is advisable to select relatively thin yarn of low stretchability as the elastic yarn 11.

As employed herein, the term“stretchability” refers to both of the characteristic of being able to change in state from an unstretched (normal) state to a stretched state and the characteristic of being able to restore from the stretched state to the normal state in an instant on release of tension. Proper changes can be made as to whether the first knitted fabric 1 of the invention and the non-conductive portion 3 are identical or differ from each other in the degree of stretchability. For example, the stretchability of each of the first knitted fabric 1 of the invention and the non-conductive portion 3 may be determined with the aim of rendering creases or undulating wrinkles inconspicuous on the knitted fabric as a whole, or set at a moderate level aimed at avoiding damage to the conductive yarn 10 under a load of tension.

The extent to which the knitted fabric in the unstretched state is stretched (the degree of stretching) can be controlled by making proper changes to various factors as to materials (yarn) used for knitting operation, including materials, thickness, whether interweaving of various yarn is adopted or not, interweaving technique (covering, plating, or paralleling some yarns together), the number of yarn to be interwoven, and the strip width and strip length of the conductive part 2, on an as needed basis.

Moreover, it goes without saying that the degree of stretching varies depending on the compositions and structures of selected materials. In this case, the loop length of the conductive yarn 10, the elastic modulus of the elastic yarn 11, and adjustment of drafting (elongation and narrowing of fibers) are key factors especially in the knitting design of the first knitted fabric 1 of the invention.

As to elastic restoration, hundred-percent restoration to the original length in the unstretched state is ideal. However, it is not compulsory to achieve the hundred-percent restoration, and, performance capabilities may be determined according to applications. For example, on the basis of the specified number of repeated cycles of stretching and contraction, a product which is capable of restoration of a 90-percent level or above within the range of the specified number is rated as a conforming item. However, with failure of a product to reach 100^{th} cycle of stretching and contraction, it must be said to be substantially impractical.

“The number of repeated cycles of stretching and contraction” can be counted by cyclic tensile tests using De Mattie-type Repeat Endurance Tester. In this case, a rectangular piece whose long side is aligned with the course direction is obtained from the conductive part 2 (or the first knitted fabric 1 of the invention) as a test piece. In this embodiment, the test piece is 5 cm in long side and 2 cm in short side. Moreover, in the case of obtaining the test piece from the conductive part 2, nylon-made SCY is used for the non-conductive portion 3 to protect the first knitted fabric 1 of the invention from stretching influence (interference). Furthermore, the test piece is held securely at its ends in the course direction (each area to be held is about 1.5 cm in length) by proper fixing means to prevent the elastic yarn 11 interwoven with the test piece from coming off during repetition of stretching actions. As exemplary of the fixing means, a polyurethane-made hot-melt film may be laminated so as to be immersed in the knitted fabric.

The first knitted fabric 1 of the invention behaves so that the contact area and contact pressure of the conductive yarn 10 varies with a change in fabric's state between a stretched state and an unstretched state under the tightening force (contraction force) of the elastic yarn 11. It is thus advisable to design the first knitted fabric 1 of the invention to undergo maximum contraction when in the unstretched state, because this makes it possible to change the contact area and contact pressure of the conductive yarn 10 while providing high stretchability (for example, 150%).

Even greater stretchability can be attained by the use of thick polyurethane yarn or high-elastic-modulus polyurethane yarn having high restorability (kickback) against stretching action with high draft (shorter loop length), or by secondarily feeding relatively thin elastic yarn 11 (such as polyurethane yarn) in the path of the conductive yarn 10 together (independently of inlay knitting). In this case, it is expected that the conductive yarn 10 will be slackened for easy contact with an adjacent loop.

Besides, the use of woolly-finished plated yarn or covered yarn with a cover of plated yarn is suitable for use in facilitating the contact between the conductive layers 10.

### EXAMPLES

While the following describes actual implementation examples of the first knitted fabric 1 of the invention, the disclosure will be made for a better understanding of the technical details of the present invention, and the technical scope of the present invention is not limited to the following examples.

### Example 1

Single stitch (plain stitch) has been conducted with use of silver-metallized fibers (Nylon multifilament manufactured by Mitsufuji Corporation under the product name of AGposs (78 dt/34 f) as the conductive yarn 10 and polyurethane yarn (235 dt) as the elastic yarn 11. The elastic yarn 11 has been interwoven by inlay motion as shown in FIG. 2 (denoted [A] in Table 1) with high draft.

As employed herein, the term “high draft” means that polyurethane yarn is fed in the stretched state during knitting operation. In the case of feeding polyurethane yarn with high draft, the tightening force produced by the polyurethane yarn is effectively exerted on a knitted fabric in finished form when free of external restraints. Inconsequence, the knitted fabric is characterized in that the conductive yarn 10 loops arranged adjacent each other in the course direction are kept in contact with each other.

### Example 2

Single stitch has been conducted with use of 78 dt/34 f silver-metallized fibers (AGposs) as the conductive yarn 10 and 235 dt polyurethane yarn as the elastic yarn 11. The elastic yarn 11 has been interwoven by inlay motion as shown in FIG. 4 (denoted [B] in Table 1) with high draft.

### Example 3

Fraise (Rib) knitting has been conducted with use of 78 dt/34 f silver-metallized fibers (AGposs) as the conductive yarn 10 and 235 dt polyurethane yarn as the elastic yarn 11. The elastic yarn 11 has been interwoven by inlay motion as shown in FIG. 5 (denoted [C] in Table 1) with high draft.

### Example 4

Single plating knitting has been conducted with use of 78 dt/34 f silver-metallized fibers (AGposs) as the conductive yarn 10 and 110 dt polyurethane yarn as the elastic yarn 11. That is, plating knitting was adopted for the interweaving of the elastic yarn 11. Moreover, the polyurethane yarn has been interwoven with high draft.

### Example 5

Fraise plating knitting has been conducted with use of 78 dt/34 f silver-metallized fibers (AGposs) as the conductive yarn 10 and 110 dt polyurethane yarn as the elastic yarn 11. That is, plating knitting was adopted for the interweaving of the elastic yarn 11. Moreover, the polyurethane yarn has been interwoven with high draft.

TABLE 1

| | | | | Example 1 | Example 2 | Example 3 | Example 4 | Example 5 |
|---|---|---|---|---|---|---|---|---|
| Conductive yarn | | | | Silver- | Silver- | Silver- | Silver- | Silver- |
| [thickness/ | | | | metallized | metallized | metallised | metallized | metallized |
| filament number] | | | | fiber | fiber | fiber | fiber | fiber |
| | | | | [78 dt/34 f] | [78 dt/34 f] | [78 dt/34 f] | [78 dt/34 f] | [78 dt/34 f] |
| Knit structure of | | | | Single | Single | Fraise | Single | Fraise |
| conductive yarn | | | | | | | | |
| Elastic yarn | | | | Polyurethane | Polyurethane | Polyurethane | Polyurethane | Polyurethane |
| [thickness] | | | | [235 dt] | [235 dt] | [235 dt] | [110 dt] | [110 dt] |
| Elastic yarn | | | | Inlay A | Inlay B | Inlay C | Plating | Plating |
| Interweaving system | | | | | | | | |
| Stretching | Measurements | 3 | cm | 4.2 | 2.8 | 3.5 | 1.8 | 1.9 |
| length- | | 3.5 | cm | 4.7 | 3.0 | 5.3 | 2.0 | 2.1 |
| resistance | | 4 | cm | 6.4 | 3.5 | 5.6 | 2.2 | 2.3 |
| [Ω] | | 4.5 | cm | 7.1 | 4.9 | 5.9 | 2.3 | 2.4 |
| correlation | | 5 | cm | 7.5 | 5.7 | 6.0 | 2.5 | 2.6 |
| | | 5.5 | cm | 7.6 | 6.3 | 6.0 | 2.8 | 2.8 |

* dt represents abbreviated expression of dtex
* Nylon multifilament manufactured by Mitsufuji Corporation under the product name of AGposs is used for silver-metallized fiber

Data on the stretching length-resistance correlation given in Table 1 has been obtained by the following testing method.

That is, in this test, there was prepared a test piece which is 5 cm in long side and 2 cm in short side (the conductive portion and each of the opposite non-conductive portions have short sides of 1 cm and 0.5 cm, respectively), and chucking portions of a size of 1 cm were formed one at each end of the test piece in the direction of its length. The chucking portion was obtained by lamination of a polyurethane hot-melt film under heat to prevent accidental separation of polyurethane bare yarn.

The test piece was set so as to obtain a span of 3 cm in the unstretched state (at no load of tension), with each chucking portion grippingly held in position. Then, the now spanning test piece has been stretched step by step in increments of 0.5 cm within the test length range of 3 cm to 5.5 cm for measurement of resistance value at each stretching step.

As is apparent from the correlation between stretching and resistance given in Table 1, the first knitted fabric 1 of the invention (Examples 1 to 3) has been found to exhibit noticeable resistance variations according to the degree of stretching.

It is to be understood that the application of the present invention is not limited to the specific embodiments described heretofore, and that various changes and modifications may be made therein.

For example, the first knitted fabric 1 of the invention is not limited in knit form to a tubular fabric, but maybe knitted in non-tubular form. That is, the first knitted fabric 1 of the invention can be produced by knitting operation using a commonly-used knitting machine such as a circular knitting machine or a flat knitting machine.

In the first knitted fabric 1 of the invention, the conductive yarn 10 may be knitted in, instead of the described plain-knitted or rib-knitted structure, a smooth-knitted structure, or modified forms of these structures. For example, a fabric of eight lock, cordlane, or cross tuck knitted with insertion yarn may be given by way of example. To sum up, it is essential only that the condition where the adjacent conductive yarn loops make contact with each other be achieved by interweaving the elastic yarn 11 such as polyurethane yarn with the conductive yarn 10 by means of inlay motion, plating stitch, feeding some yarns together, or otherwise.

In addition to being applied to the described distortion sensor, by virtue of its characteristic of varying in electrical resistance according to the degree of stretching, the first knitted fabric 1 of the invention finds widespread applications in many fields (including power-feeding applications, signal applications, and medical applications).

Besides the conductive yarn 10 and the elastic yarn 11, knitting yarn for stretching prevention purposes (preferably non-elastic yarn, but use can be made of yarn which is limited in its stretching movement by application of twist or knit-structure adjustment) maybe interwoven. It is advisable to apply the knitting yarn and knitting design of the non-conductive portion 3 to the stretching preventive yarn.

A metallic wire can be used for the conductive yarn 10. Examples of the metallic wire include one made of pure metal such as aluminum, nickel, copper, titanium, magnesium, tin, zinc, iron, silver, gold, platinum, vanadium, molybdenum, tungsten, or cobalt, one made of an alloy of suchmetals, one made of stainless steel, and one made of brass. In some cases, carbon fiber can be used instead of the metallic wire.

It is preferable that the metallic wire or other has a (wire) diameter in a 10 μm- to 200 μm range. It is possible to use a bundle of (metallic) fibers of small diameter. Note that there is no particular limitation to the metallic wire or other in respect of its easiness in plastic deformation or its possession of remarkable restorability (resilience), for example.

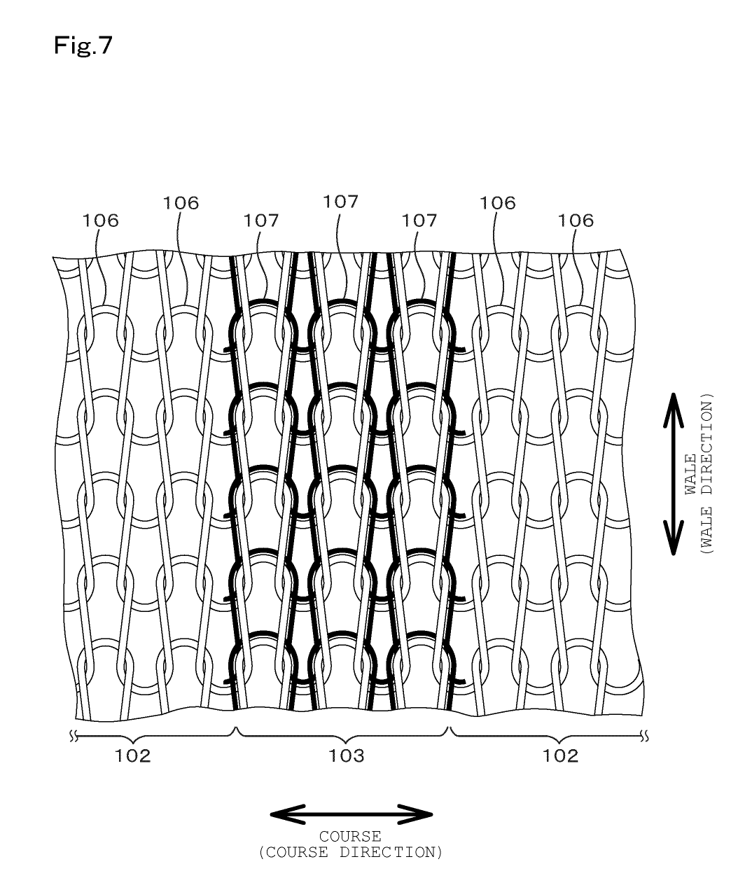

FIGS. 7 to 11A and 11B are views showing a conductive elasticized knitted fabric 100 implemented as the second embodiment of the present invention (hereafter referred to as “the second knitted fabric 100 of the invention”) that differs from the first knitted fabric 1 of the invention that has been described referring mainly to FIGS. 1 and 2.

The second knitted fabric 100 of the invention has, as a principal structural feature, a knit structure composed of at least one non-conductive knit region 102 and at least one wale conductive strip 103 that are arranged adjacent each other.

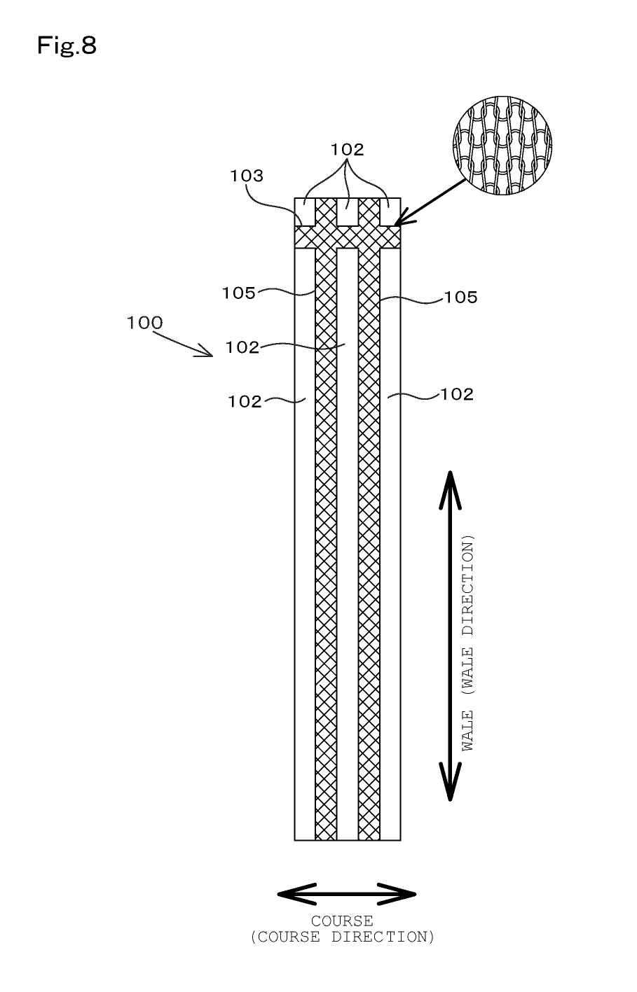

In the second embodiment, as shown in FIG. 8, the second knitted fabric 100 of the invention is shaped in a flat strip (tape) as a whole, in which the wale conductive strip 103 is located at one end of the tape in the direction of its length so as to run across the width of the tape (located in the upper end-side part of the tape so as to run horizontally as viewed in FIG. 8). Besides, two paralleled course conductive strips 105 are located centrally of the tape in the direction of its width so as to run lengthwise of the strip (run in a vertical direction as viewed in FIG. 8). The two course conductive strips 105 are each intersected by the wale conductive strip 103.

The described non-conductive knit region 102 constitutes all the regions of the tape except for the wale conductive strip 103 and the two course conductive strips 105. In this arrangement, it can be said that the non-conductive knit regions 102 lie one on each side of the wale conductive strip 103 (lie so as to have sandwiched therebetween the wale conductive strip 103 in the vertical direction as viewed in FIG. 8), as well as lie one on each side of each of the course conductive strip 105 (lie so as to have sandwiched therebetween the course conductive strip 105 in the horizontal direction as viewed in FIG. 8).

As shown in FIG. 7, the term “course direction” refers to the direction in which continuous loops 106 are formed one after another to define a knit structure. In this description, “the course direction” coincides with “course”. Moreover, the term “wale direction” refers to a direction perpendicular to the course direction on the surface of the knitted fabric. In this description, “the wale direction” coincides with “wale”. With this in view, the term “course number” refers to the number of courses arranged side by side in the wale direction, and the term “wale number” refers to the number of wales arranged side by side in the course direction.

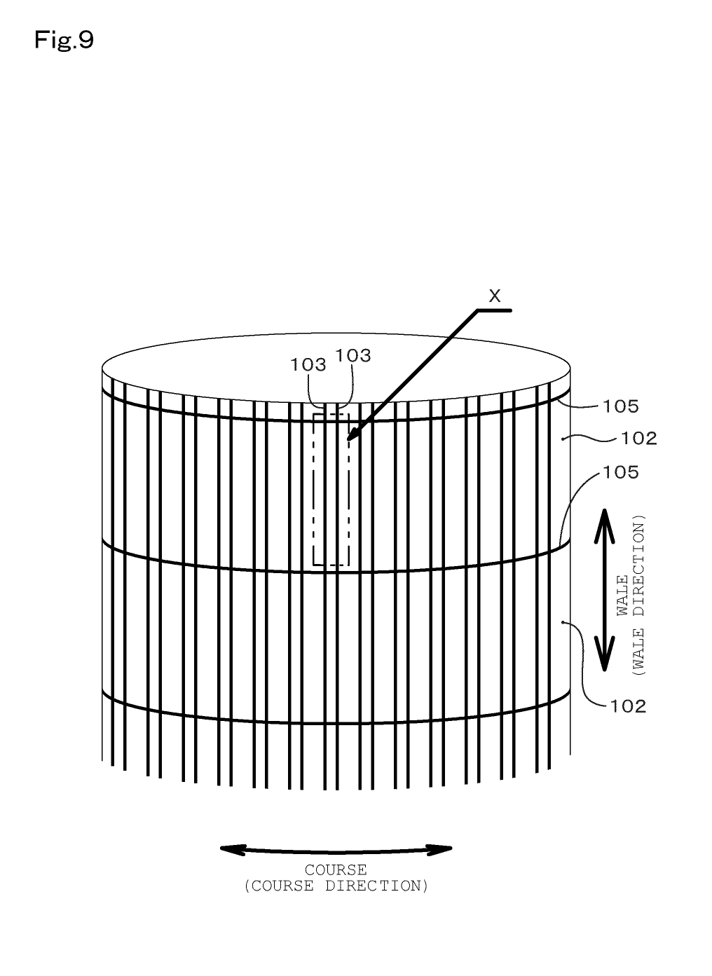

As additional remarks, in the case of, for example, a tubular fabric knitted by a circular knitting machine as shown in FIG. 9, a direction circumferentially of the tubular fabric (the direction to proceed knitting) corresponds to the course direction, and the direction of length of the tubular fabric (the direction in which the fabric structure is lengthened as knitting proceeds) corresponds to the wale direction.

In the second knitted fabric 100 of the invention exemplified as the second embodiment, the strip-shaped body as a whole is basically knitted out of non-conductive yarn, and, when knitting at least the wale conductive strip 103 therein, conductive yarn is interwoven through cut-boss process with non-conductive yarn used as base yarn. For example, paralleling some yarns together, plating, or inlay can be adopted as the interweaving technique. Moreover, while the course conductive strip 105 can be knitted by means of paralleling some yarns together, plating, inlay, cross weave, or otherwise, the course conductive strip 105 may be formed solely of conductive yarn with changes of yarn stitch (without using non-conductive yarn).

In any case, the non-conductive knit region 102 constituting other region of the knitted fabric than the wale conductive strip 103 and the course conductive strip 105 is apparently formed of the non-conductive yarn-made loops 106 (free of conductive yarn). As the non-conductive yarn, use can be made of synthetic fiber (made of nylon or polyester, for example), natural fiber, elastic yarn such as polyurethane yarn, and synthetic fiber-elastic yarn composite materials (including those in the form of covered yarn or twist yarn, and those obtained by interweaving using a technique such as paralleling some yarns together, plating, feeding some yarns together, or inlay during knitting). The non-conductive yarn may be designed either in monofilament form or multifilament form without limitation.

Thus, each of the wale conductive strip 103 and the course conductive strip 105 has the characteristic of exhibiting electrical conduction at its area between any given two longitudinally spaced apart points, whereas the non-conductive knit region 102 has the characteristic of electrical isolation.

By exploiting these characteristics, when setting the wale conductive strip 103 and the course conductive strips 105 in an arrangement as shown in FIG. 8, it is possible to form an electric circuit which extends from the lower end of the left-hand course conductive strip 105 (as viewed in FIG. 8), through the wale conductive strip 103 connected to the upper part of the left-hand course conductive strip 105, to the upper part of the right-hand course conductive strip 105 (as viewed in FIG. 8), and from there to the lower end of the right-hand course conductive strip 105. In this arrangement, the wale conductive strip 103 constitutes a short-circuit path serving as the connection between the right-hand and left-hand course conductive strips 105.

As described above, since the wale conductive strip 103 and the course conductive strip 105 are each situated between the non-conductive knit regions 102 in sandwich relation, it is possible to keep most part of the outer periphery of the second knitted fabric 100 of the invention in an electrically insulated condition, and thereby minimize problems such as electrical shortings or leakage of current that may occur in the wale conductive strip 103 or the course conductive strip 105 upon contact with other object.

In the second knitted fabric 100 of the invention, the entire strip-shaped body is produced by yarn knitting, wherefore not only the non-conductive knit region 102 but also the wale conductive strip 103 and the course conductive strip 105, that is, the whole area is free to stretch both in the strip-length direction and in the strip-width direction. Moreover, the second knitted fabric 100 of the invention has flexibility of high enough level to warp or bend freely in a front-back direction, bend rightward and leftward along the plane of the fabric body, and twist freely.

The following mainly describes further details of the wale conductive strip 103. As shown in FIG. 7, the wale conductive strip 103 is formed of a chain of loops 107 of conductive yarn (hereafter referred to as “conductive yarn loops 107”) arranged in the wale direction. As employed herein, the term “conductive yarn” refers to a bare yarn material with a metallic component left exposed on yarn surface. Moreover, the term “chain of loops” means that the conductive yarn loops 107 arranged adjacent each other in the wale direction are kept in contact with each other at least at one point (in FIG. 8, four bottom points and four head points, or a total of eight points per conductive yarn loop 107) in an electrically conducting condition.

To be specific, it is preferable to use, as the conductive yarn, metal-deposited yarn obtained by depositing a metallic component on a core such as resin fiber, natural fiber, or a metallic wire by means of wet coating, dry coating, plating, vacuum film deposition, or otherwise (plated yarn). Although monofilament yarn can be used for the core, multifilament yarn or spun yarn is better than monofilament yarn, or, bulky yarn, such as woolly-finished yarn, covered yarn such as SCY or DCY, or fluffy-finished yarn, is more preferable for use.

As the metallic component deposited on the core, use can be made of, for example, pure metal such as aluminum, nickel, copper, titanium, magnesium, tin, zinc, iron, silver, gold, platinum, vanadium, molybdenum, tungsten, and cobalt, an alloy of such metals, stainless steel, and brass.

A metallic wire can be used for the conductive yarn. In this case, as described earlier, the metallic wire can be formed of a wire made of metal such as pure metals of various types, an alloy of these metals, stainless steel, or brass, and preferably the metallic wire has a wire diameter in a 10 μm- to 200 μm range. Moreover, it is possible to use a bundle of metallic fibers of small diameter. Note that there is no particular limitation to the metallic wire in respect of its easiness in plastic deformation or its possession of remarkable restorability (resilience), for example. In some cases, carbon fiber can be adopted instead of the metallic wire.

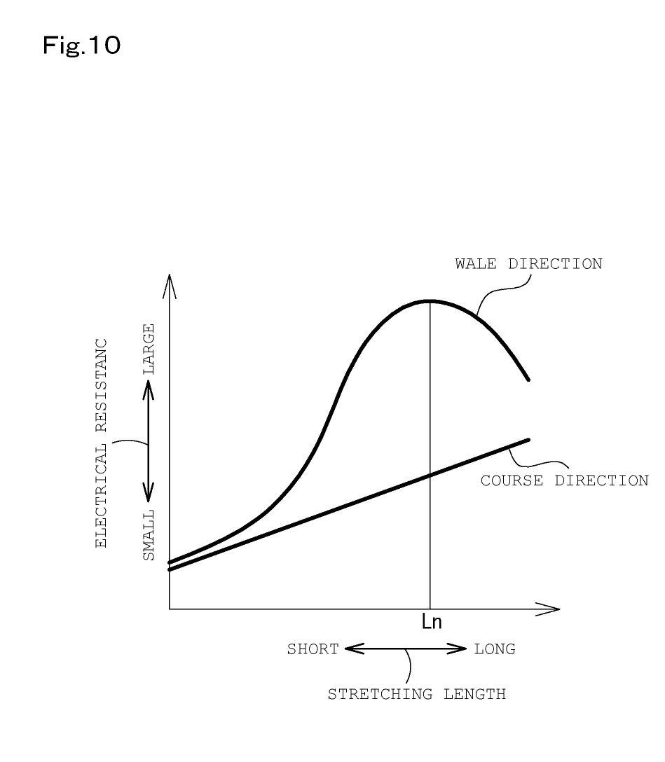

Moreover, the study done by the present inventors has shown that the wale conductive strip 103, while being free to stretch both in the wale direction and in the course direction because of its being knitted out of non-conductive yarn as base yarn as above described, is capable of providing a relationship such that electrical resistance is increased or decreased according to the degree of stretching (stretching length) of the strip in the course direction, and is also capable of providing, in many cases, a relationship such that electrical resistance is increased or decreased according to stretching length in the wale direction. In FIG. 10, there is shown an example of the correlation between the degree of stretching (stretching length) and electrical resistance in the wale conductive strip 103.

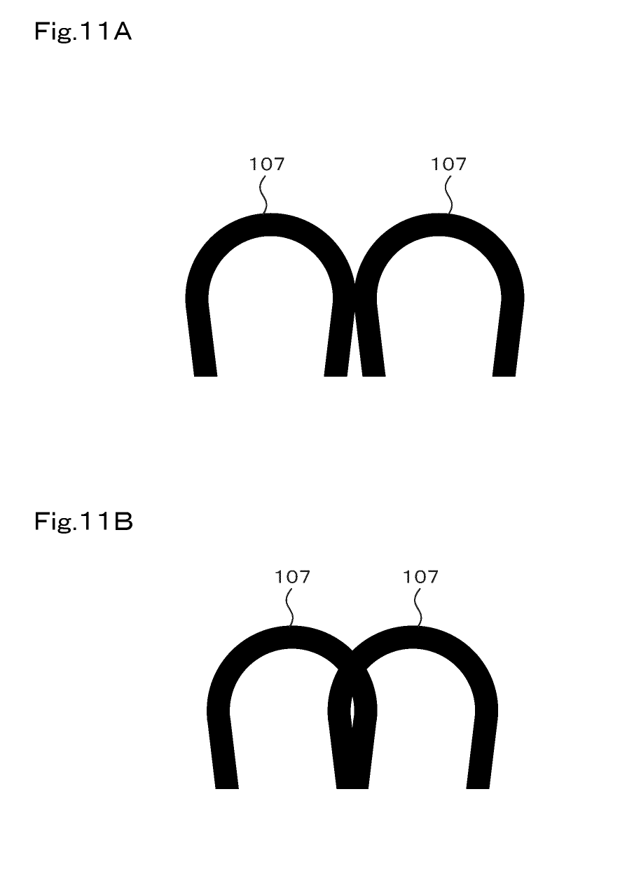

FIG. 10 corresponds to the case as shown in FIG. 7 where the wale conductive strip 103 takes on a 3-wale form (three rows of the conductive yarn loops 107 are arranged in the course direction). In FIG. 7, three rows of the conductive yarn loops 107, viz., three wales of the conductive yarn, are arranged side by side (spaced apart) in order in an unstretched state (normal state). However, FIG. 7 is a merely schematic representation for a better understanding of the arrangement, and thus, in reality, some adjacent conductive yarn loops 107 make contact in contiguous relation with each other as shown in FIG. 11A, and others make contact in partly overlying relation with each other as shown in FIG. 11B.

As is apparent from FIG. 10, when the wale conductive strip 103 is stretched in the course direction, the electrical resistance tends to increase proportionally as the stretching length is increased. On the other hand, when the wale conductive strip 103 is stretched in the wale direction, although the electrical resistance tends to increase gradually as the stretching length is increased at the early stage of stretching, upon a predetermined stretching length (Ln) being exceeded, the electrical resistance tends to decrease inversely proportionally.

The stretching length-electrical resistance correlation shown in FIG. 10 is not always obtainable without fail. That is, there may be a case where a correlation different from that as shown in FIG. 1 is obtained, depending on various combined factors as to the base yarn (non-conductive yarn), including materials for use, thickness, yarn type (filament form), and knit structure, as well as factors as to the wale conductive strip 103, including configuration, the number of wales, materials adopted for conductive yarn, thickness, and yarn type (filament form).

Presumably, the occurrence of variations in electrical resistance as shown in FIG. 10 is due to the following factors. That is, when the wale conductive strip 103 is pulled in the wale direction, the conductive yarn loop 107 becomes deformed so that its dimension in the wale direction increases, and the dimension in the course direction decreases correspondingly (hereafter referred to as “longitudinally stretching deformation”). Then, as a matter of course, on release of the tension exerted thereon, the conductive yarn loop 107, now undergoing longitudinally stretching deformation, is restored to a state prior to its being loaded with the tension (unstretched state).

The reason why an increase in electrical resistance occurs as the conductive yarn loop 107 undergoes longitudinally stretching deformation is probably because transitions of the condition of contact between the conductive yarn loops 107 take place, and more specifically, for example, the conductive yarn loops 107 arranged in the course direction in a condition of making contact in partly overlying relation with each other as shown in FIG. 11B are brought into a contiguously contacting condition as shown in FIG. 11A with a decrease in contact area, and are eventually brought out of contact with each other for separation as shown in FIG. 7. Moreover, the conductive yarn loops 107 arranged in the wale direction also encounter a decrease in the number of contact points and a decrease in the area of contact per contact point. This can be considered as another reason.

The reason why the electrical resistance tends to decrease when the wale conductive strip 103 is stretched further to such an extent that the predetermined stretching length (Ln) is exceeded is probably because, in the case of adopting multifilament yarn for the conductive yarn, when the conductive yarn loop 107 has reached a permissible upper limit of its deformation in the wale direction, the coupling between the filament portions becomes tighter and tighter (the yarn diameter becomes narrower and narrower) with a consequent rise in contact pressure, causing an increase in the area of contact and an ensuing decrease in electrical resistance.

On the other hand, the reason why a decrease in electrical resistance occurs as the conductive yarn loop 107 restores from the longitudinally-stretching deformed state is probably because transitions of the condition of contact between the conductive yarn loops 107 take place, and more specifically, for example, the conductive yarn loops 107 arranged in the course direction in a spaced-apart condition as shown in FIG. 7 or contiguously contacting condition as shown in FIG. 11A is brought into contact in partly overlying relation with each other as shown in FIG. 11B with an increase in contact area. Moreover, the conductive yarn loops 107 arranged in the wale direction also encounter an increase in the number of contact points and an increase in the area of contact per contact point. This can be considered as another reason.

When the wale conductive strip 103 is pulled in the course direction, the conductive yarn loop 107 becomes deformed so that its dimension in the course direction increases, and the dimension in the wale direction decreases correspondingly (hereafter referred to as “transversely stretching deformation”). Then, as a matter of course, on release of a tension exerted thereon, the conductive yarn loop 107, now undergoing transversely stretching deformation, restores to a state prior to its being loaded with the tension (unstretched state).

In this case, apparently, the area of contact between the conductive yarn loops 107 arranged in the course direction changes according to the degree of stretching (stretching length) of the wale conductive strip 103 in the course direction, and also the electrical resistance changes proportionately.

As is apparent from the above description, the wale conductive strip 103 is characterized in that the electrical resistance is increased under a load of tension exerted in the wale direction until the level of stretching has reached the predetermined stretching length (Ln), yet is decreased on release of the tension. With the exploitation of such electrical resistance variation characteristics, equipment such as a switching circuit or a distortion sensor can be constructed.

Besides, the second knitted fabric 100 of the invention is formed in a base-yarn knit structure, and thus affords air permeability, moisture permeability, and water absorbability. Hence, the attachment of the second knitted fabric 100 of the invention to garments (all of wearable cloths and items including upper wears, lower wears, gloves, and socks) will not cause wearer's discomfort resulting from heat and humidity. Moreover, the second knitted fabric 100 of the invention has the characteristic of being able to change in shape flexibly so as to follow wearer's body movement. It can thus be said that the second knitted fabric 100 of the invention is suitable for use in wearable material application.

The course conductive strip 105 (refer to FIG. 8) can be defined as continuous rows of the conductive yarn loops 107 of the wale conductive strip 103 arranged in the course direction (the course conductive strip and the wale conductive strip are substantially identical in basic structure). Hence, the course conductive strip 105 exhibits conductivity at its area between any given two points spaced apart in the course direction, and also provides the same effects as achieved in the case where the wale conductive strip 103 undergoes stretching and contraction in the course direction when stretched and contracted in the course direction. It is needless to say that the course conductive strip 105 has the characteristic of varying in electrical resistance according to the degree of stretching.

To produce the thereby configured second knitted fabric 100 of the invention, as exemplified in FIG. 9, the method of knitting a tubular fabric by a circular knitting machine may be adopted. That is, non-conductive yarn is knitted on and on in the course direction while cut-boss process is being performed repeatedly at the location where the wale conductive strip 103 is to be formed with conductive yarn. As a matter of course, a fabric region knitted during the time interval between the withdrawal of conductive yarn in the cut-boss process and the next insertion of conductive yarn constitutes the non-conductive knit region 102. Moreover, in the course of such a knitting operation to lengthen the fabric structure in the wale direction, interweaving of conductive yarn is done along the course direction at the location where the course conductive strip 105 is to be formed.

The second knitted fabric 100 of the invention can be obtained by cutting a part as indicated by the arrow X in FIG. 9 out of the tubular fabric so obtained by the knitting operation.

To prevent the arrow-indicated part X from raveling at its cut edge during cutting process, it is advisable to apply or interweave heat-fusible yarn such as polyurethane yarn as base yarn (non-conductive yarn), and perform heat setting treatment (heating treatment) thereon before the cutting process. That is, by the heat setting treatment, the non-conductive yarn loops 106 arranged in the course direction, as well as in the wale direction, are thermally fused or bonded to each other, thus imparting a clean cut to the cut edge.

In the second embodiment, as shown in FIG. 8, there are provided a single course conductive strip 105 and two paralleled wale conductive strips 103 intersected by the course conductive strip 105, and, the course conductive strip 105 constitutes a short-circuit path for the two wale conductive strips 103.

In this regard, the second knitted fabric 100 of the invention can be designed so that the wale direction and the course direction are arranged in the place of each other (as a third embodiment). That is, in the third embodiment, there are provided a single wale conductive strip 103 and two paralleled course conductive strips 105 intersected by the wale conductive strip 103, and, the wale conductive strip 105 constitutes a short-circuit path for the two course conductive strips 105.

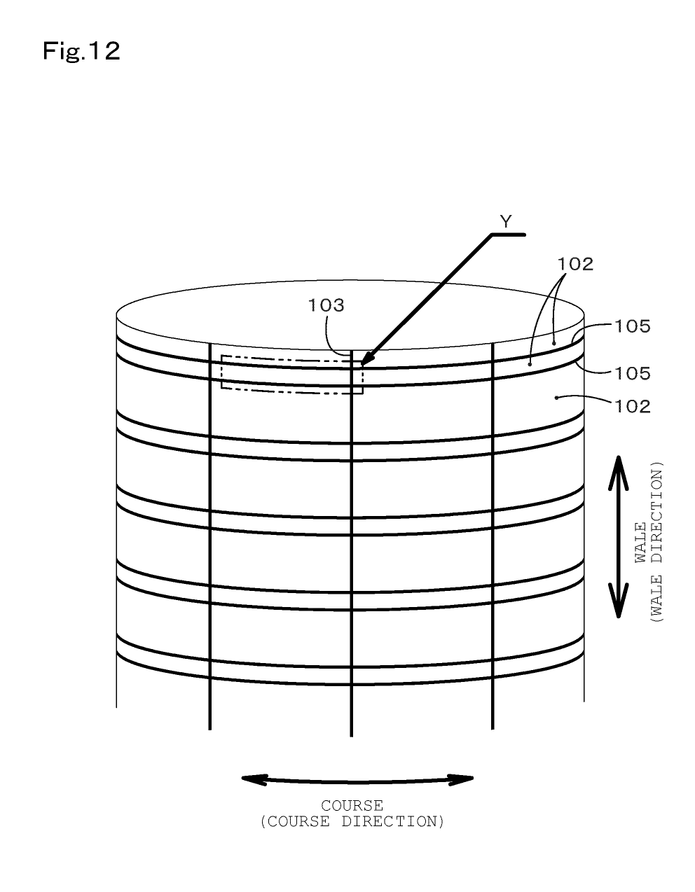

The second knitted fabric 100 of the invention in accordance with the third embodiment can be obtained by cutting a part as indicated by the arrow Y in FIG. 12 out of a tubular fabric knitted as shown in FIG. 12.

In the third embodiment, the strip-length direction of the second knitted fabric 100 of the invention is aligned with the course direction, and there is thus the need to elongate the course conductive strip 105.

In this case, it is preferable that elastic yarn is interwoven in parallel relation with non-conductive yarn used as base yarn by means of plating, feeding some yarns together, inlay, or otherwise to enhance the stretchability in the course direction.

As employed herein, the term “stretchability” refers to both of the characteristic of being able to change in state from an unstretched (normal) state to a stretched state and the characteristic of being able to restore from the stretched state to the normal state in an instant on release of tension. Moreover, the term “elastic yarn” refers to a material which remains contracted at no load of tension (unstretched state, viz., normal state), stretches freely under a load of tension in accordance with the level of the tension, and restores from the stretched state to the original contracted state when brought into a no-load condition on release of the tension.

Specifically, to form the elastic yarn, an elastomeric material such as polyurethane or a rubber material may be used alone, or, for example, use can be made of covered yarn composed of a “core” made of an elastomeric material such as polyurethane or a rubber material and a “cover” made of nylon or polyester. The use of such a covered yarn makes it possible to impart various features, including an affinity for water, water repellency, resistance to corrosion, and coloration, to the second knitted fabric 100 of the invention. Moreover, its use is effective at providing a smooth texture and exercising stretching control.

It is advisable to select materials used for the elastic yarn with consideration given to the fact that stretching of the conductive yarn used for the course conductive strip 105 has to be limited so as not to exceed the maximum stretching limit. When adopting covered yarn as the elastic yarn, a material which lends itself to stretching control on the conductive yarn can be selected as a material used for the “cover”. Moreover, the selection of materials used for the elastic yarn in itself or the “cover” may be made with the aim of attaining adaptability to stretching and contracting behaviors required of the second knitted fabric 100 of the invention.

The extent to which the knitted fabric in the unstretched state is stretched (the degree of stretching) can be controlled by making proper changes to various factors as to the conductive yarn, including materials, thickness, interweaving technique (covering, plating, or knitting with some yarn together), the number of yarn to be interwoven, on an as needed basis.

It is to be understood that the application of the present invention is not limited to the specific embodiments described heretofore, and that various changes and modifications may be made therein.

For example, it goes without saying that, also in the second embodiment, elastic yarn can be interwoven for the purpose of attaining greater stretchability in the course direction.

The number of wales constituting the strip width of the wale conductive strip 103 (the number of the conductive yarn loops 107 arranged in the course direction) and the number of the wale conductive strips 103 to be formed are not limited to any particular values. As a matter of course, a reduction in electrical resistance value in the wale conductive strips 103 can be achieved by increasing the number of wales, by selecting a low-resistance material, by increasing material thickness, or by increasing the amount of metallic plating. Besides, the smaller the flexural rigidity the better, because excellent expansion and contraction properties can be obtained. It is thus advisable to tie fibers of small fiber diameter in a bundle.

Likewise, the number of courses constituting the strip width of the course conductive strip 105 (the number of the conductive yarn loops 107 arranged in the wale direction) and the number of the course conductive strips 105 to be formed are not limited to any particular values. In some cases, the course conductive strip 105 does not necessarily have to be provided.

Moreover, there is no particular limitation to the arrangement of both of the conductive strips 103 and 105. For example, it is possible to arrange a single wale conductive strip 103 and a single course conductive strip 105 in the form of the letter L or a cross.

The shape of the second knitted fabric 100 of the invention is not limited to a strip, but may be of a clothing article form, for example.

The second knitted fabric 100 of the invention is not limited in knit form to a tubular fabric, but may be knitted in non-tubular form. That is, the second knitted fabric 100 of the invention can be produced by knitting operation using a commonly-used knitting machine such as a circular knitting machine or a flat knitting machine.

In addition to being applied to the described switching circuit or distortion sensor, by virtue of its characteristic of varying in electrical resistance according to the degree of stretching, the second knitted fabric 100 of the invention finds widespread applications in many fields (includingpower-feedingapplications,signalapplications,and medical applications).

### EXPLANATION OF REFERENCE SYMBOLS

1 Conductive elasticized knitted fabric (First knitted fabric of the invention)
2 Conductive part
3 Non-conductive part
10 Conductive yarn
11 Elastic yarn
100 Conductive elasticized knitted fabric (Second knitted fabric of the invention)
102 Non-conductive knit region
103 Wale conductive strip
105 Course conductive strip
106 Loop (Non-conductive yarn)
107 Loop (Conductive yarn)

1. An electrical resistance-variable conductive elasticized knitted fabric which is a knitted fabric for which a direction in which continuous loops are formed one after another in a knit structure is defined as a course direction or a course, in which the loops are formed of conductive yarn, and elastic yarn is positioned so as to exhibit a tightening force in the course direction, the knitted fabric being designed so that, when in an unstretched state, the conductive yarn loops arranged adjacent each other in the course direction are kept in contact with each other under the tightening force of the elastic yarn, whereas, in a state of being stretched in the course direction, the conductive yarn loops are movable away from each other against the tightening force of the elastic yarn.

2. The electrical resistance-variable conductive elasticized knitted fabric according to claim 1,
wherein the conductive yarn is knitted by weft knitting.

3. The electrical resistance-variable conductive elasticized knitted fabric according to claim 1,
wherein the elastic yarn is knitted in the course direction from a knitting point which is the same as or different from a knitting point from which is fed the conductive yarn.

4. The electrical resistance-variable conductive elasticized knitted fabric according to claim 1,
wherein the elastic yarn is interwoven in the course direction by inlay knitting.

5. The electrical resistance-variable conductive elasticized knitted fabric according to claim 4,
wherein the elastic yarn is held securely at opposite ends of the knitted fabric in the course direction by fixing means for yarn retention.

6. A conductive part comprising:
a conductive portion; and
a non-conductive portion placed next to the conductive portion,
the conductive portion being a knitted fabric for which a direction in which continuous loops are formed one after another in a knit structure is defined as a course direction or a course, in which the loops are formed of conductive yarn, and elastic yarn is positioned so as to exhibit a tightening force in the course direction,
the conductive part being designed so that, when the knitted fabric is in an unstretched state, the conductive yarn loops arranged adjacent each other in the course direction are kept in contact with each other under the tightening force of the elastic yarn, whereas, when the knitted fabric is in a state of being stretched in the course direction, the conductive yarn loops are movable away from each other against the tightening force of the elastic yarn.

7. The electrical resistance-variable conductive elasticized knitted fabric according to claim 2,
wherein the elastic yarn is knitted in the course direction from a knitting point which is the same as or different from a knitting point from which is fed the conductive yarn.

8. The electrical resistance-variable conductive elasticized knitted fabric according to claim 2,
wherein the elastic yarn is interwoven in the course direction by inlay knitting.
